(19) United States
(12) Patent Application Publication
(10) Pub. No.: US 2013/0219097 A1
(43) Pub. Date: Aug. 22, 2013

(54) MODULE ON BOARD FORM FACTOR FOR EXPANSION BOARDS

(71) Applicant: Chun-Tai WANG, New Taipei City (TW)

(72) Inventor: Chun-Tai WANG, New Taipei City (TW)

(73) Assignee: QUALCOMM ATHEROS, INC., San Jose, CA (US)

(21) Appl. No.: 13/495,883

(22) Filed: Jun. 13, 2012

Related U.S. Application Data
(60) Provisional application No. 61/601,333, filed on Feb. 21, 2012.

(51) Int. Cl. G06F 13/00

(52) U.S. Cl. 710/301

(57) ABSTRACT

A new form factor for circuit boards can be employed for directly connecting an expansion board to a motherboard without the need for PCIe hardware such as sockets, retainers, screw and nut assemblies, and connectors. The module on board form factor for an expansion board comprises a first side of the expansion board and a second side of the expansion board located physically opposite to the first side of the expansion board. The first side of the expansion board comprises one or more components configured to provide functionality associated with the expansion board. The second side of the expansion board comprises a plurality of connection leads, such as solder connections, that directly couple the expansion board to the motherboard.

### RELATED APPLICATION

This application claims the priority benefit of U.S. Provisional Application Ser. No. 61/601,333 filed on Feb. 21, 2012.

### BACKGROUND

Embodiments of the inventive subject matter generally relate to the field of circuit design and, more particularly, to a module on board form factor for expansion boards.

Peripheral Component Interconnect Express (PCIe) is a commonly used computer expansion board standard. PCIe expansion slots, PCIe connectors, and PCIe retaining mechanisms are typically employed to attach expansion boards (and/or other expansion hardware) to a motherboard of an electronic device to extend the functionality of the motherboard (and consequently the electronic device).

### SUMMARY

Various embodiments of a module on board form factor for expansion boards are disclosed. In one embodiment, an apparatus comprises a motherboard and an expansion board directly coupled with the motherboard. The expansion board is operable to extend functionality associated with the motherboard. The expansion board comprises a first side of the expansion board and a second side of the expansion board located physically opposite to the first side of the expansion board. The first side of the expansion board comprises one or more components configured to provide functionality associated with the expansion board. The second side of the expansion board comprises a plurality of connection leads that directly couple the expansion board to the motherboard.

### BRIEF DESCRIPTION OF THE DRAWINGS

The present embodiments may be better understood, and numerous objects, features, and advantages made apparent to those skilled in the art by referencing the accompanying drawings.

FIG. 1A is a top view of an example module on board (MoB) expansion board;

FIG. 1B is a bottom view of an example MoB expansion board;

FIG. 1C is a front view of an example MoB expansion board;

FIG. 2A illustrates an example mechanism for connecting an expansion board to a motherboard using a PCIe standard;

FIG. 2B illustrates example PCIe connectors implemented on the expansion board for connecting the expansion board to the motherboard using the PCIe standard; and

FIG. 3 is a block diagram of one embodiment of a motherboard coupled with a MoB expansion board.

### DESCRIPTION OF EMBODIMENT(S)

The description that follows includes exemplary systems, methods, techniques, instruction sequences, and computer program products that embody techniques of the present inventive subject matter. However, it is understood that the described embodiments may be practiced without these specific details. For instance, although examples describe that the connecting leads of the circuit board are arranged in a grid, embodiments are not so limited. In other embodiments, the connecting leads of the circuit board can be arranged in any suitable configuration. In other instances, well-known instruction instances, protocols, structures, circuits, and techniques have not been shown in detail in order not to obfuscate the description.

Connecting a conventional expansion board to a motherboard using the PCIe standard involves the use of additional hardware such as a PCIe socket, a PCIe retainer, a screw and nut assembly, and connecting leads. The PCIe socket is typically included on the motherboard and the PCIe connectors are included on one edge of the expansion board. The PCIe connectors can be plugged into the PCIe socket to connect the expansion board to the motherboard. The PCIe retainer is typically located on an opposite edge of the expansion board to provide stability and minimize movement of the expansion board. The PCIe retainer can be affixed to the expansion board using the screw and nut assembly. This additional hardware (e.g., the PCIe socket, the PCIe retainer, the PCIe connectors, and the screw and nut assembly) can add to the dimensions and size of the expansion board. Because computing devices are getting smaller and cheaper, expansion boards that are connected (to the motherboard) using the PCIe standard may be too large, unwieldy, costly, and impractical to implement in smaller form factors.

In some embodiments, a new form factor for circuit boards can be employed for connecting a circuit board to a motherboard. This new form factor is herein referred to as a “Module on Board” or “MoB.” Circuit boards, such as expansion boards, can be designed based on the MoB form factor to mount the expansion board directly onto the motherboard without the need for PCIe sockets on the motherboard, PCIe retaining mechanisms on the expansion board, screw and nut assemblies, and PCIe connectors that are mounted on the edge of the expansion board. Such expansion boards that are designed based on the MoB form factor for directly connecting the expansion board to the motherboard are herein referred to as “MoB expansion boards.” This can reduce the dimensions and size of the expansion board and can reduce the footprint of the expansion board (e.g., the total space required to attach the expansion board to the motherboard). Employing the MoB expansion board can further result in smaller and more compact motherboard and system designs. Also, eliminating the PCIe socket, the PCIe retainer, the PCIe connectors, and the screw and nut assembly can reduce the cumulative cost of the MoB expansion board. Furthermore, directly connecting the MoB expansion board to the motherboard instead of plugging the expansion board into a PCIe socket (e.g., in accordance with the PCIe standard) can improve thermal performance of the MoB expansion board, the motherboard, and the resultant electronic device.

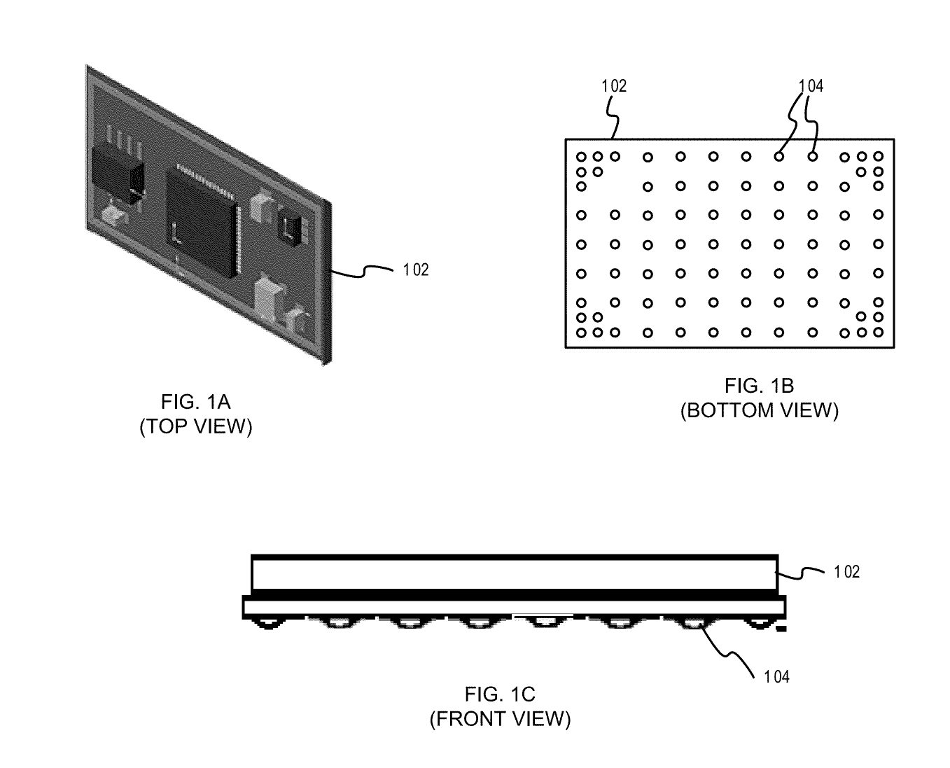

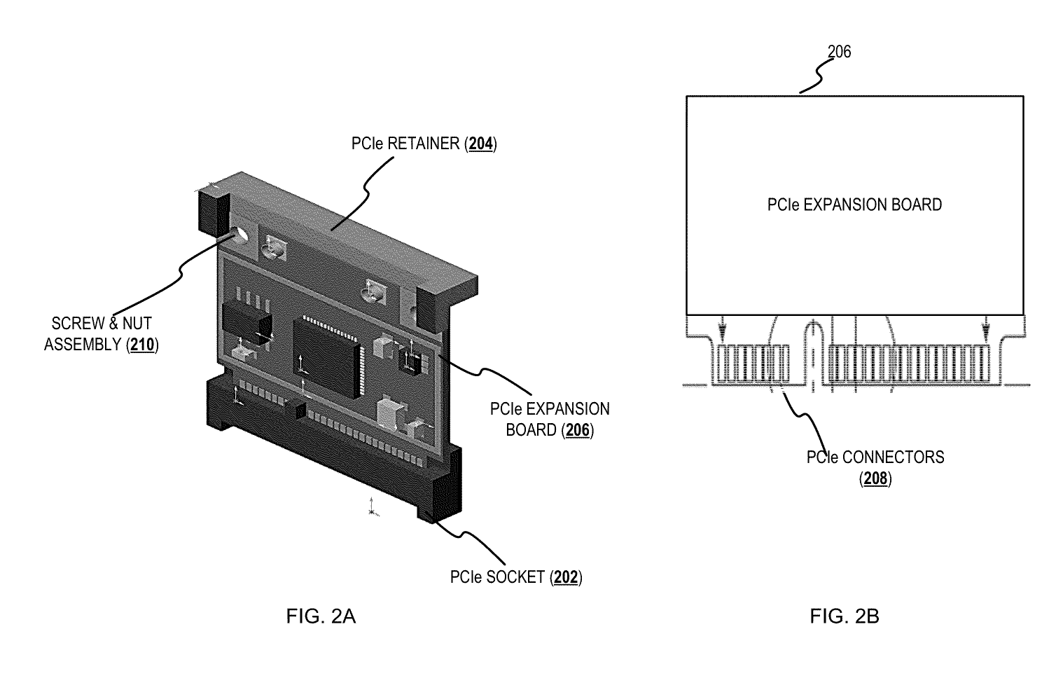

FIG. 1A, FIG. 1B, and FIG. 1C depict the top view, the bottom view, and the front view of a MoB expansion board respectively. As depicted by FIG. 1A, the top view of the MoB expansion board 102 comprises one or more electrical components that are connected to provide the functionality of the MoB expansion board 102. The electrical components can comprise one or more integrated circuits, resistors, capacitors, inductors, inter-connections, and other suitable components. FIG. 2A and FIG. 2B depict an example mechanism for connecting a PCIe expansion board 206 to the motherboard (not shown) using the PCIe standard. FIGS. 1A-1C will be described in conjunction with FIGS. 2A-2B to distinguish between the motherboard coupling mechanism using the MoB expansion board 102 (FIGS. 1A-1C) and the motherboard coupling mechanism using the PCIe standard (FIGS. 2A-2B). As discussed above, using the PCIe standard to connect the PCIe expansion board 206 of FIG. 2A to the motherboard (not shown) involves the use of additional hardware such as a PCIe socket 202, a PCIe retainer 204, a screw and nut assembly 210, and PCIe connectors 208 (depicted in FIG. 2B). Implementing the PCIe socket 202, the PCIe retainer 204, the PCIe connectors 208, and the screw and nut assembly 210 can add to the dimensions and size of the PCIe expansion board 206.

As depicted by FIG. 1A, the MoB expansion board 102 does not comprise the PCIe connectors 208, the PCIe retainer 204, and the screw and nut assembly 210. As depicted by FIG. 1B, the bottom view of the MoB expansion board 102 depicts multiple connecting leads 104 that enable the MoB expansion board 102 to be directly connected to the motherboard without implementing additional hardware and connection sockets (e.g., the PCIe socket 202) on the motherboard. In other words, instead of using the PCIe connectors 208 (of FIG. 2B), the MoB expansion board 102 can use connecting leads (e.g., solder balls, pins, a combination of the solder balls and pins, etc.) that are directly connected to the motherboard as depicted by FIG. 1B. Furthermore, instead of using the PCIe connectors 208 that are positioned at the edge of the PCIe expansion board 206 to enable connection to the PCIe socket 202, the MoB expansion board 102 can use connecting leads 104 on the bottom of the MoB expansion board 102 to enable direct connection to the motherboard. This is further illustrated by the front view of the MoB expansion board 102 in FIG. 1C. In one example, mounting the pads of an interface bus array (e.g., the connecting leads) to the bottom of the MoB expansion board 102 can enable the MoB expansion board 102 to be soldered horizontally onto the motherboard so that the MoB expansion board 102 is parallel to the surface of the motherboard. It is noted that the motherboard can be implemented as part of an electronic device such as a laptop computer, a tablet computer, a mobile phone, a smart appliance, a gaming console, a camera, or other suitable electronic devices.

In some embodiments, the connecting leads 104 that connect the MoB expansion board 102 to the motherboard can be arranged in a grid on the bottom face of the MoB expansion board, as depicted by FIG. 1B. In other embodiments, the connecting leads 104 that connect the MoB expansion board 102 to the motherboard may be located along the sides (or the corners) of the bottom face of the MoB expansion board 102. In another embodiment, the connecting leads 104 that connect the MoB expansion board 102 to the motherboard may be arranged in another suitable formation or pattern. In some embodiments, the layout of the components on the MoB expansion board 102, the routing between components on the MoB expansion board 102, and inter-connections (e.g., wires and metal connections that connect two or more components together) may be re-designed to position the connecting leads 104 at the bottom of the MoB expansion board 102. It should also be noted that the top view of the expansion board depicted in FIG. 1A may be diametrically opposite to the bottom view of the expansion board depicted in FIG. 1B. Although, in some embodiments, the components of the MoB expansion board 102 may be located on the top side of the MoB expansion board 102 and the connecting leads 104 may be located on the bottom of the MoB expansion board 102, embodiments are not so limited. In other embodiments, the components may be located on the bottom of the MoB expansion board 102 and the connecting leads 104 may be located on the top of the MoB expansion board 102. In some embodiments, the components and the connecting leads 104 may be located on the same side of the MoB expansion board 102.

It should be understood that the Figures described herein are examples meant to aid in understanding embodiments and should not be used to limit embodiments or limit scope of the claims. Embodiments may include different or additional components, components in a different arrangement, perform additional operations, fewer operations, operations in a different order, operations in parallel, and some operations differently. For example, in some embodiments as described above in FIG. 1B, the connecting leads 104 that connect the MoB expansion board 102 to the motherboard can be arranged in a grid. However, in other embodiments, the number of connecting leads, the spacing between individual connecting leads, and the configuration in which the connecting leads are arranged can vary depending on the size of the MoB expansion board 102, the number of components on the MoB expansion board 102, and other such size and connectivity considerations.

It should also be understood that although examples refer to techniques for connecting the MoB expansion board to a motherboard using connecting leads positioned at the bottom of the MoB expansion board, embodiments are not so limited. In other embodiments, the techniques described herein can be employed for affixing any suitable circuit boards together. For example, a first expansion board may be affixed to a second expansion board using techniques described herein. Additionally, more than two circuit boards may be affixed to each other using the techniques described herein.

In some embodiments, the MoB expansion board can be a double-sided expansion board. Thus, components that provide additional functionality (e.g., integrated circuits, interconnections, etc.) can be implemented on the both sides (i.e., opposite sides, or top and bottom sides) of the double-sided expansion board. The connecting leads that attach the double-sided expansion board to the motherboard can be placed on any suitable side (i.e., on the top side or the bottom side) of the double-sided expansion board.

In some embodiments, directly connecting the MoB expansion board 102 to the motherboard by eliminating the PCIe socket 202, the PCIe retainer 204, the screw and nut assembly 210, and the PCIe connectors 208 can also reduce the footprint of the expansion board. In one embodiment, the footprint of the expansion board using the PCIe standard (“PCIe expansion board”) can be 31.5 mm×37 mm (i.e., 1165.5 mm²), while the footprint of the MoB expansion board can be 25 mm×18 mm (i.e., 450 mm²), resulting in a 61% smaller footprint. In some embodiments, the size of the expansion board itself may be reduced when implementing the new MoB form factor because the MoB expansion board may not require additional board space (e.g., for a screw and nut assembly) to accommodate the PCIe retainer/the PCIe connectors, etc. For example, the size of the PCIe expansion board may be 26.8 mm×30 mm (i.e., 804 mm²), while the size of the MoB expansion board may be 25 mm×18 mm (i.e., 450 mm²), resulting in a 44% smaller size. It should be noted that the sizes and footprints of the PCIe expansion board and the MoB expansion board are examples provided for illustrative purposes. In other embodiments, the PCIe expansion board and/or the MoB expansion board can have other suitable dimensions, sizes, and footprints.

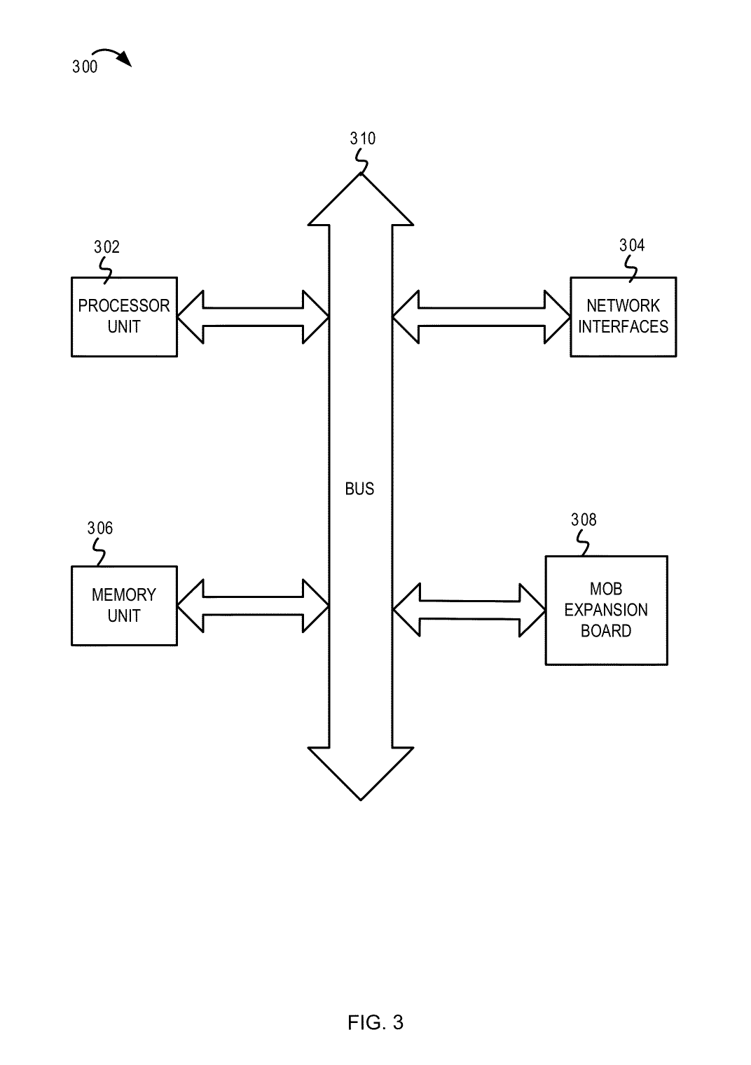

FIG. 3 is a block diagram of one embodiment of an electronic device 300 including a MoB expansion board. In some embodiments, the electronic device 300 can comprise a motherboard. In this embodiment, the electronic device 300 can be a notebook computer, a desktop computer, a tablet computer, a netbook, a mobile phone, a gaming console, a smart appliance, or other electronic systems with/without communication capabilities. In other embodiments, the electronic device 300 may be a motherboard to which the MoB expansion board is to be directly coupled. In this embodiment, the electronic device 300 (i.e., the motherboard) can be implemented within notebook computer, a desktop computer, a tablet computer, a netbook, a mobile phone, a gaming console, a smart appliance, or other electronic systems. In the example of FIG. 3, the electronic device 300 includes a processor unit 302 (possibly including multiple processors, multiple cores, multiple nodes, and/or implementing multi-threading, etc.). The electronic device 300 includes a memory unit 306. The memory unit 306 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable storage media. The electronic device 300 also includes a bus 310 (e.g., PCI, ISA, PCI-Express, HyperTransport®, InfiniBand®, NuBus, AHB, AXI, etc.), and network interfaces 304 that includes a wireless network interface (e.g., a WLAN interface, a Bluetooth® interface, a WiMAX interface, a ZigBee® interface, a Wireless USB interface, etc.) and/or a wired network interface (e.g., an Ethernet interface, a powerline interface, etc.). The processor unit 302, the memory unit 306, and the network interfaces 304 are coupled to the bus 310.

The electronic device 300 also includes a MoB expansion board 308. As described above with reference to FIGS. 1A-1C, the MoB expansion board 308 can be directly connected (e.g., soldered) onto the motherboard to connect the MoB expansion board 308 to the motherboard without the use of a PCIe socket (or another type of connection hardware). In some embodiments, the electronic device 300 may include fewer or additional components not illustrated in FIG. 3 (e.g., video cards, audio cards, additional network interfaces, peripheral devices, etc.). For example, although illustrated as being coupled to the bus 310, the memory unit 306 may be coupled to the processor unit 302.

While the embodiments are described with reference to various implementations and exploitations, it will be understood that these embodiments are illustrative and that the scope of the inventive subject matter is not limited to them. In general, a module on board form factor for expansion boards as described herein may be implemented with facilities consistent with any hardware system or hardware systems. Many variations, modifications, additions, and improvements are possible.

Plural instances may be provided for components, operations, or structures described herein as a single instance. Finally, boundaries between various components, operations, and data stores are somewhat arbitrary, and particular operations are illustrated in the context of specific illustrative configurations. Other allocations of functionality are envisioned and may fall within the scope of the inventive subject matter. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. An apparatus comprising:
a motherboard; and
an expansion board directly coupled with the motherboard, the expansion board operable to extend functionality associated with the motherboard, the expansion board comprising:
a first side of the expansion board, wherein the first side of the expansion board comprises one or more components configured to provide functionality associated with the expansion board; and
a second side of the expansion board located physically opposite to the first side of the expansion board, wherein the second side of the expansion board comprises a plurality of connection leads that directly couple the expansion board to the motherboard.

2. The apparatus of claim 1, wherein the plurality of connection leads directly couple the expansion board to the motherboard such that the first side and the second side of the expansion board are substantially parallel to a plane of the motherboard.

3. The apparatus of claim 1, wherein the one or more components configured to provide functionality of the expansion board comprise one or more electrical components and interconnections between the electrical components.

4. The apparatus of claim 1, wherein the plurality of connection leads are arranged in a grid on the second side of the expansion board.

5. The apparatus of claim 1, wherein the plurality of connection leads are solder balls that directly couple the expansion board to the motherboard.

6. The apparatus of claim 1, wherein the plurality of connection leads are connecting pins and solder balls that directly couple the expansion board to the motherboard.

7. The apparatus of claim 1, wherein the expansion board is a double sided expansion board, wherein the second side of the expansion board comprises one or more additional components configured to provide the functionality associated with the expansion board.

8. The apparatus of claim 1,
wherein the motherboard does not comprise a matching socket for the expansion board; and
wherein the plurality of connection leads on the second side of the expansion board directly couple the expansion board to the motherboard without the matching socket.

9. An circuit board comprising
a first side of the circuit board, wherein the first side of the circuit board comprises one or more components configured to provide functionality associated with the circuit board; and
a second side of the circuit board located physically opposite to the first side of the circuit board, wherein the second side of the circuit board comprises a plurality of connection leads to be used to directly couple the circuit board to a motherboard.

10. The circuit board of claim 9, wherein the circuit board is an expansion board, the expansion board operable to extend functionality associated with the motherboard.

11. The circuit board of claim 9, wherein the plurality of connection leads are solder balls that directly couple the circuit board to the motherboard such that the first side and the second side of the circuit board are substantially parallel to a plane of the motherboard.

12. The circuit board of claim 9, wherein the one or more components configured to provide functionality of the circuit board comprise one or more electrical components and interconnections between the electrical components.

13. The circuit board of claim 9, wherein the plurality of connection leads are arranged in a grid on the second side of the circuit board.

14. The circuit board of claim 9, wherein the circuit board is a double sided circuit board, wherein the second side of the circuit board comprises one or more additional components configured to provide the functionality associated with the circuit board.

15. The circuit board of claim 9,
wherein the motherboard does not comprise a matching socket for the circuit board; and
wherein the plurality of connection leads on the second side of the circuit board directly couple the circuit board to the motherboard without the matching socket.

16. The circuit board of claim 9,
wherein the plurality of connection leads are solder balls that are used to directly couple the circuit board to the motherboard, or
wherein the plurality of connection leads are connecting pins and solder balls that are used to directly couple the circuit board to the motherboard.

17. An expansion board comprising:
a first side of the expansion board, wherein the first side of the expansion board comprises one or more components configured to provide functionality associated with the expansion board; and
a second side of the expansion board located physically opposite to the first side of the expansion board,
wherein the second side of the expansion board comprises a plurality of solder connection leads to be used to directly couple the expansion board to a motherboard such that the first side and the second side of the expansion board are substantially parallel to a plane of the motherboard,
wherein the second side of the expansion board does not comprise a socket connector and the motherboard does not comprise a matching socket for the expansion board.

18. The expansion board of claim 17, wherein the expansion board is a double sided expansion board, wherein the second side of the expansion board comprises one or more additional components configured to provide the functionality associated with the expansion board.

19. The expansion board of claim 17, wherein the one or more components configured to provide functionality of the expansion board comprise one or more electrical components and interconnections between the electrical components.

20. The expansion board of claim 17, wherein the plurality of solder connection leads are arranged in a grid on the second side of the expansion board.
